(19) United States
(12) Patent Application Publication
(10) Pub. No.: US 2016/0373184 A1
(43) Pub. Date: Dec. 22, 2016

(54) COMMUNICATION DEVICE FOR AIRBORNE SYSTEM

(71) Applicant: THALES, Courbevoie (FR)

(72) Inventors: Engin ODER, Tournefeuille (FR); Florence ZAMBETTI, Cugnaux (FR)

(21) Appl. No.: 14/901,806

(22) PCT Filed: Jul. 4, 2014
(86) PCT No.: PCT/EP2014/064379

§ 371 Date: Dec. 29, 2015

(30) Foreign Application Priority Data
Jul. 5, 2013 (FR) 1301598

(51) Int. Cl. H04B 7/185; H04W 76/02

(52) U.S. Cl. CPC H04B 7/18506; H04W 76/023; H04W 4/008

(57) ABSTRACT

A unitary communication device onboard an aircraft comprises, in a single equipment, avionics means for sending and receiving data to/from avionics applications, and non-avionics means for sending and receiving data to/from non-avionics applications. The device comprises the avionics means are coupled across a secure firewall within the equipment to the non-avionics means by serial or parallel communication links and in that the avionics and non-avionics means comprise a plurality of communication interfaces able to communicate respectively with the avionics applications and non-avionics applications, and means able to share computing resources to operate, onboard the aircraft, the avionics and non-avionics applications.

### FIELD OF THE INVENTION

The invention relates to the field of systems installed in aircraft and more particularly that of piloting assistance and on-line maintenance.

### PRIOR ART

During flights, pilots always have the need to access information in order to adapt their flight plan to situations. Some data are provided directly by the onboard system, such as the information on the waypoints for example, but other items of information are not accessible in real time on board the aircraft in flight because they come from the outside or open world and are available outside of the aeronautical environment.

As a concrete example, during a cruise flight phase a pilot may have to divert to a different airport from that of his initial destination or the diversion airport indicated in the initial flight plan. Such a case of unforeseen diversion can be due to meteorological situations or a failure encountered on the aircraft. It may even be related to a sick passenger making it necessary to shorten the flight

In such diversion cases, pilots are confronted with the choice of landing on an airport that is not that of the planned destination but which must be adapted to the situation.

In order to confirm their choice, pilots have to integrate information relating to the diversion airport, that is to say:

if it is accessible according to regulations, that is to say if the visibility is sufficient to be able to land;

if the airport meets the requirements of the situation, for example by being close to a hospital or if the necessary maintenance equipment is available on site;

if there is a local hotel infrastructure capable of accommodating all of the passengers;

if it will be possible to route passengers to their final destination knowing that there is a railroad station or a well served road infrastructure nearby;

if the weather is suitable for arriving at this destination; or

if the performance of the aircraft and the conditions of the day make the landing compatible with the runway.

These items of information and their accessibility greatly increase the pilots' understanding of the situation and are important elements with regard to the safety of flights. Various items of information are therefore necessary in real time to allow pilots to decide on the diversion airport.

However, there are no simple and efficient means for accessing information in real time in existing onboard systems. Yet it is essential that this information be available in due time in order to modify the fight plan whilst in flight.

The current architecture in avionics commonly based on terminals, is out of date in comparison with modern applications which use resources having “man-machine dialog” orientation.

Even though recent information technology such as tablets or portable equipments which have become available to end-users, these later present problems to airline companies wishing to modernize their onboard information technology equipments.

In fact, suppliers of applications in the field of avionics for navigation and maintenance have either had to develop new applications which can simultaneously operate on several platforms, such as IOS, Android, Windows 7 or 8, or Linux, or to develop as many applications as there are platforms.

Thus, there is the need for a universal, versatile and unified onboard architecture which can support:

any type of application, whatever the platform may be for which it is designed; and

any platform for any application with unified ergonomics.

Moreover, such architecture must allow a connection between portable devices located in the cockpit and the existing avionic equipment. It must also allow two-way communication with the ground.

Furthermore, such architecture must be sufficiently robust in terms of security so as to avoid any contamination or diversion, because the data conveyed are sensitive items of data belonging to the airline and to its operations.

Although the existing onboard systems meet some of the requirements above-mentioned, they exhibit disadvantages which do not allow proposing an overall multi-platform and multi-application architecture. The known systems are flight management systems, or FMS (Flight Management Systems) systems, according to the appropriate English terminology, or mission preparation systems commonly referred to in English as “Electronic Flight Bag (EFB)”.

The disadvantages of FMS-type systems are that the information needed by the pilots to complete their missions correctly are either in paper files generated on the ground by the services of the operations center of the airline company (AOC) and inputs fulfilled in the FMS by the pilots, or by direct transmission from the AOC to the FMS through a VHF or ACARS communication or “data link” according to English terminology. In this system, the AOC applications intended for the pilots are not all automatized. They necessitate sustained effort from the pilots and induce a waste of time for the pilots. At present, only the “flight plan” application can be transmitted directly from the AOC to the FMS avionics, solely on aircraft provided with ACARS or having data loading means known as “gatelink” in English terminology. The diversion airports where the pilots could land are for example provided in a book of possible diversion airports upon which it is possible to land depending on the technical data of the aircraft and the route.

Therefore the FMS system does not allow the automatization and simplification of the pilots' tasks. Moreover, the FMS does not allow rapid access to correct information at the right time, which is required for real time information which cannot be provided in advance.

EFB systems are associated with a ground station integrated in the flight operations of the airline or a service provider. The applications developed for the EFB systems are hosted on heterogeneous platforms at operating system level and at the hardware level. They are therefore specified and developed for a given platform and consequently depend on platforms and function for which they are intended. Thus, the current EFB architectures exhibit some disadvantages as each architecture is based on a single and non versatile technology, either PC technology or tablets technology.

There is therefore a need for an architecture offering the capability of functioning with heterogeneous applications on assorted platforms whilst allowing communication between portable equipments and the onboard avionics systems.

The present invention meets this requirement.

### BRIEF DESCRIPTION OF THE INVENTION

A purpose of the present invention is to propose a device making it possible to manage heterogeneous and assorted applications and allowing communication between portable equipments and the existing onboard avionics means.

The device of the invention has the advantage of communicating with any type of tablet (Android, IOS, Win8, etc . . . ) and offering an interface with the onboard avionics means.

Another purpose of the present invention is to propose an architecture capable of hosting the heterogeneous and assorted applications, both the Flight Deck ones (EFB, pilots) and the Flight Ops (Operational Center) and maintenance (Maintenance Operations) ones which by their very nature necessitate being compatible through assorted and heterogeneous applications and platforms.

Advantageously, thanks to its logic and physical architecture, the device of the invention is capable of supporting all applications and data relating to the “Flight” and Maintenance” fields of flight, whatever their operating environment, PC or Tablet.

Advantageously, the device of the invention provides the information and the documents necessary for the pilots (PNT) tasks, for the maintenance operators of the aircraft and for the cabin crew (PNC) in their functions.

Advantageously, the device of the invention operates like an onboard equipment in an architecture having air/ground communication means and information providers.

For this purpose, the invention relates to a unitary communication device onboard an aircraft including, in a single equipment, avionics means for sending and receiving data to/from avionics applications, and non-avionics means for sending and receiving data to/from non-avionics applications. The device is characterized:

in that the avionics means are coupled to the non-avionics means and the equipment through an internal secure firewall by means of by serial or parallel communication links

and in that the avionics and non-avionics means comprise multiple communication interfaces able to communicate respectively with the avionics applications and non-avionics applications, and with means able to manage the sharing of computing resources so as to operate, the avionics and non-avionics applications onboard the aircraft.

Advantageously, the communication interfaces are wired or wireless interfaces. In particular, the communication interfaces able to communicate with the avionics applications are interfaces of the ARINC 664 group, and the communication interfaces able to communicate with the non-avionics applications Wifi, Bluetooth, 3G, LTE and Ethernet.

Moreover, according to the invention, the device comprises specific interfaces for satellite communications.

Advantageously, the means of managing the information resources comprise virtualization components which use virtual machines and a hypervisor.

According to a preferred embodiment, the device of the invention comprises remote display means to allow the display of data onboard the aircraft on dialog units knowing that the dialog units are crew dialog units, digital tablets of an onboard system, or maintenance portable terminals.

In a variant implementation, a system installed onboard an aircraft comprises at least two devices of the invention coupled by Ethernet communication links.

### DESCRIPTION OF THE FIGURES

Various aspects and advantages of the invention will become apparent with the help of the description of a preferred but non-limiting implementation of the invention, given with reference the figures below:

FIG. 1 is a block diagram of the system of the invention;

FIG. 2 shows a preferred implementation of the system of the invention.

### DETAILED DESCRIPTION OF THE INVENTION

In order to allow a good understanding of the description, a terminology list of the principal terms used is given below:

| Term | Definition |
|---|---|
| ACARS | Aircraft Communications Addressing and Reporting |
| | System - Aircraft/ground digital communication system |
| AID | Aircraft Interface Device |
| A/L | Airline |
| AOC | Airline Operation Center/Operation Center of the |
| | airline company |
| ARINC | Aeronautical Radio, Inc/Aeronautical standard |
| ARM | Microprocessor with RISC (Reduced Instruction Set |
| | Computer) architecture |
| ATIS | Automatic Terminal Information Service (Airport) |
| CCDU | Cabin Crew Dialog Unit - Dialog unit for the cabin crew |
| CMS | Centralized Maintenance |
| CPIOM | Core Processing I/O Modules - Input/output Modules of |
| | the processing core |
| EFB | Electronic Flight Bag - The pilot's electronic flight bag |
| FMS | Flight Management System |
| LRU | Line Replaceable Unit |
| MCC | Maintenance Control Center |
| MCU | Micro Controller Unit |
| METAR | METeorological Aerodrome Report - Hourly Aerodrome |
| | Routine Meteorological Report |
| NOTAM | NOTice to Airmen - Notice to AirMen |
| OS | Operating System - Operating System |
| PMAT | Portable Maintenance Access Terminal - Portable |
| | Maintenance Access Terminal |
| PNC | Commercial Flying Personnel |
| PNT | Technical Flying Personnel |
| PU | Processing Unit |
| SRU | Shop replaceable unit |
| TAF | Terminal Aerodrome Forecast - Terminal Weather |
| | Forecast |
| TEMSI | Significant Weather (Meteorological Map) |
| WDU | Wireless Dialog Unit |
| WIFI | Wireless Fidelity/wireless communication standard |
| WINTEM | WINnd and TEMperatures (Meteorological Map) - |

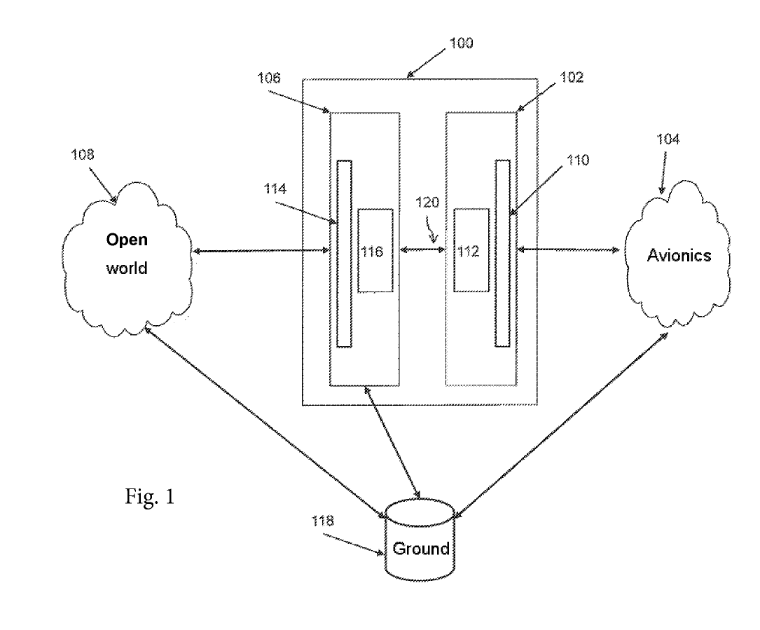

FIG. 1 is a block diagram of the device of the present invention. The device (100) comprises a first “avionics” module (102) for managing the applications of the avionics world (104), and a second “outside world” module (106) for managing the non-avionics applications of the outside word (108).

The avionics module (102) comprises different interfaces (110) to allow the communication and the data exchanges with the avionics world. The interfaces allow wired communication with the pilot dialog terminals and can be according to the environment of the ARINC 429, ARINC 664 interfaces, these interfaces being quoted only as examples without any limitation of extension to other avionics interfaces well known to those skilled in the art. The avionics module comprises moreover a central processing unit (112) for managing all of the input/output operations.

The open world module (106) comprises different interfaces (114) to allow the communications and data exchanges with the open world. The interfaces allow communication with tablet (IPad, Android, smart phones, etc.) or Personal Computer (PC) type equipment. The available interfaces can be:

Wifi interfaces for communications with tablets operating as a remote Dialog Unit (UD) or supporting native onboard applications,

or Bluetooth interfaces to allow communication with maintenance applications, in particular on-line maintenance applications.

Other interfaces can be implemented in order to communicate with servers on the ground (118), such as3G interface, LTE interface or Ethernet interface, to mention just a few of them. Advantageously, the WiFi and Bluetooth ports are set up, with regard to the frequency and amplitude ranges of their spectra, so that no onboard equipment is interfered with when these functions are used.

The open world module monde comprises moreover a central processing unit (116) for managing all of the input/output operations.

The avionics and open world modules are coupled through serial or parallel links (120) to allow exchanges between the two modules. According to the variants of implementation, the intra-module communication protocol comprises various hardware and software mechanisms which make the device safe and secure in overall terms with regard to the open world. Thus, a firewall type layer is installed in the module on the avionics side of the device in order to make the exchanges with the open world secure.

Moreover, an authentication mechanism and a mechanism allowing to filter messages according to their nature, content and destination, is implemented on the open world side in order to make exchanges from the open world secure.

Moreover the device of the invention comprises for example Iridium type satellite communication interfaces.

In a preferred implementation of the device of the invention, the open world module is produced using an industrial card based on an Intel® microprocessor and the avionics module is produced on the basis of an IMA avionics module (CPIOM module type).

Advantageously, the architecture of the system, associated with specific software modules using streaming and virtualization technologies allows the system to host any heterogeneous and assorted application in a unified environment.

The proposed architecture has the advantage of meeting numerous quality criteria and in particular:

Versatility with a single equipment for any application on different platforms, operating systems and environments such as:
Applications for Windows, Linux, Android, IOS (IPad, (phone);
Operating systems: Windows (32, 64 bits), Linux, Android, IOS

Upgradeability with an appropriate choice of hardware and software components according to the technology:
Modular hardware architecture allowing upgradeability by re-use whilst minimizing the overall cost (TSC);
Software development using a 5th generation language capable of adapting to different platforms (Windows, Android, IOS, Linux)

Continuity limiting technological obsolescence to a low number of modules:
The modularly is chosen in such a way as to optimize re-use;
The components likely to evolve are brought together in one module.

Reliability and security of the System architecture: The failure of one application can neither slow down nor interfere with another application;
The redundant hardware architecture is self-reconfigurable;

Certificability: the development is carried out according to the DO 160 standard ensuring:
Non-interference with the avionics instruments;
Electromagnetic interference (EMI), temperature and vibration tests according to DO 160/cockpit.

Thus the device comprises specific virtualization (Hypervisor), remote display software (“streaming” in English terminology) and firewall (firewall is English terminology) modules for EFB and Maintenance functions.

Advantageously the hardware and software virtualization module (Hypervisor), allows the device to make several separate virtual machines operate. The hypervisor distributes the resources of the device, such as the memory, the E/S (Inputs/Outputs), etc. in an independent and secure manner between the virtual machines under its control.

Thanks to this architecture, the applications operate on virtual machines that are separate from each other with no possible interference.

Advantageously, the remote display (streaming) module allows the pilots to display any of these applications on their terminals which can be tablets communicating with the device of the invention by WiFi.

Thus, for example, an application developed for a system with Intel architecture (Tablet PC—Windows) can operate on one of the virtual machines of the device functioning as an application server and, can be used remotely over the communication interface (IHM) located on any one of the pilot's terminals (Tablet or PC) chosen by a company thanks to the streaming technique implemented in the device.

The virtualization (Hypervisor) and streaming modules are designed according to the avionics standards, in particular, according to the DO178, DO245 avionics standards, for example.

The firewall software is specifically configured for the EFB and Maintenance applications.

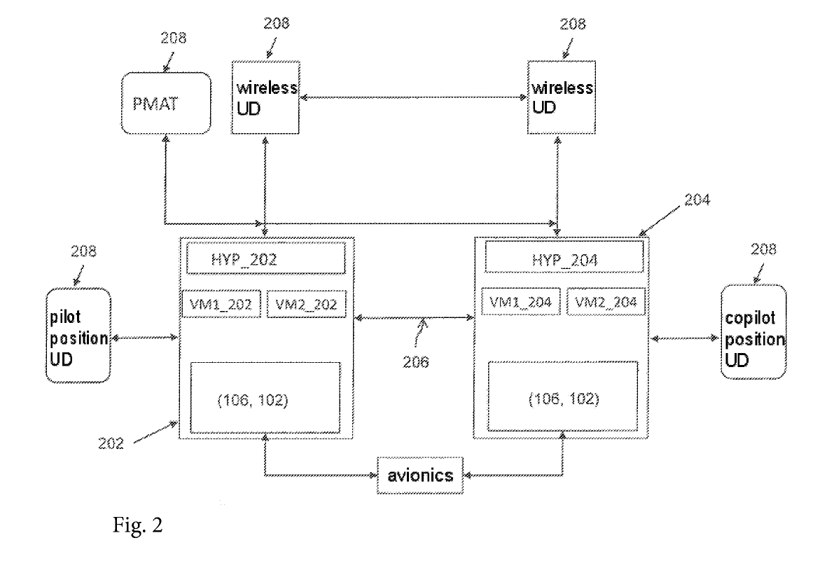

FIG. 2 shows a preferred implementation of the system of the invention. In this implementation, two devices are coupled in parallel thus making it possible to increase the reliability of the overall system.

A first device (202) comprises an avionics module (106) and an open world module (102) each one comprising the various abovementioned interfaces and central processing unit components such as described with reference to FIG. 1.

A second device (204) comprises an avionics module (106) and an open world module (102) each one comprising the various abovementioned interfaces and central processing unit components such as described with reference to FIG. 1.

The two devices (202, 204) are operationally coupled via interfaces allowing communication (206) according to the Ethernet protocol.

Each device comprises a minimum of two virtual machines, (VM1_202, VM2_202) for the first device (202) and (VM1_204, VM2_204) for the second device (204). The virtual machines operate under the supervision of a hypervisor, (HYP_202) for the first device and (HYP_204) for the second device. Advantageously, the parallel operation of the four virtual machines under the supervision of a virtual machines hypervisor allows operational security by redundancy of the “hardware” and well as redundancy of system environment by having a double virtual machine.

The hypervisors operate in parallel and each of them executes several virtual machines. The hypervisors monitor each other by a “heartbeat” mechanism where each virtual machine executes applications which can be duplicated in separate virtual machines and synchronized between the separate devices (202), (204). Thus, in the case of failure of an application on a virtual machine, the twin machine remains in operation and continues to complete the function in progress.

Thus, the “heartbeat” protocol allows the twinned applications to know by self-monitoring if the twin is in a functional state or not.

In the implementation shown in FIG. 2, any dialog unit (UD) (208) can access one of the four virtual machines by a Wifi wireless connection. The dialog units can be the tablets of the onboard system environment (EFB), the portable maintenance access terminals (PMAT) or the crew dialog units (CCDU).

Those skilled in the art will appreciate that variations can be applied to the implementation described by preferential way, whilst maintaining the principles of the invention. In particular, present invention has been described using a “dual-dual” type example having two devices in parallel, but it could have been extended to an architecture comprising several devices placed in parallel. Moreover, the hardware and/or software elements mentioned for each module of a unitary device are not limitative in the description and those skilled in the art will understand that other hardware and/or software elements carrying out the required functionality can be used.

To summarize, the main advantages of the invention provided by the described architecture are:
The support of different piloting aid software packages whatever the software (operating system) and hardware (processor architecture) target may be;
The support of different hardware environments (Intel, ARM, etc.);
The support of heterogeneous applications;
The support of several operating systems;
The support of different decision-making assistance software packages for pilots.

1. A unitary communication device onboard an aircraft comprising, in a single equipment:
avionics means for sending and receiving data to/from avionics applications, and
non-avionics means for sending and receiving data to/from non-avionics applications,
wherein the avionics means are coupled through a secure firewall within said equipment to the non-avionics means by serial or parallel communication links and in that the avionics and non-avionics means comprise:
several communication interfaces able to communicate respectively with the avionics applications and non-avionics applications; and
means able to share computing resources to operate, onboard the aircraft, the avionics and non-avionics applications.

2. The device as claimed in claim 1, wherein the communication interfaces are wired or wireless interfaces.

3. The device as claimed in claim 1 wherein, the communication interfaces able to communicate with the avionics applications are interfaces of the ARINC group and the communication interfaces able to communicate with the non-avionics applications are interfaces of the Wifi, Bluetooth, 3G, LTE and Ethernet group.

4. The device as claimed in claim 1, comprising moreover satellite communication interfaces.

5. The device as claimed in claim 1, wherein the means of managing the information resources comprise virtualization components.

6. The device as claimed in claim 5, wherein the virtualization components comprise virtual machines and a hypervisor.

7. The device as claimed in claim 1, comprising moreover remote display means to allow the display of data on dialog units onboard the aircraft.

8. The device as claimed in claim 7, wherein the dialog units are crew dialog units, digital tablets of an onboard system or portable terminals for maintenance access.

9. A system installed onboard an aircraft comprising at least two devices as claimed in claim 1, wherein said at least two devices are coupled by Ethernet communication links.
